(19) United States
(12) Patent Application Publication
(10) Pub. No.: US 2007/0254209 A1
(43) Pub. Date: Nov. 1, 2007

(54) Non-aqueous electrolyte battery

(76) Inventors: Yasunori Baba, Osaka (JP); Naoki Imachi, Osaka (JP); Atsushi Kaiduka, Osaka (JP); Yoshinori Kida, Osaka (JP); Shin Fujitani, Osaka (JP)

Correspondence Address: KUBOVCIK & KUBOVCIK, SUITE 710, 900 17TH STREET NW, WASHINGTON, DC, 20006, US

(21) Appl. No.: 11/723,183

(22) Filed: Mar. 16, 2007

(30) Foreign Application Priority Data
Mar. 17, 2006 (JP) 2006-074557

(51) Int. Cl. H01M 2/14

(52) U.S. Cl. 429/129

(57) ABSTRACT

A battery has a positive electrode active material containing an olivine lithium phosphate-based compound having an elemental composition represented as LiMPO₄, where M is a transition metal including at least Fe. The product of a separator thickness x (μm) and a separator porosity y (%) is controlled to be equal to or less than 1500 (μm·%). A porous layer containing inorganic particles and a binder is disposed between the separator and the positive electrode and/or between the separator and the negative electrode.

### BACKGROUND OF THE INVENTION

1. Field of the Invention

The present invention relates to improvements in non-aqueous electrolyte secondary batteries, such as lithium-ion batteries and polymer batteries, and more particularly to, for example, a battery structure that is excellent in cycle performance and storage performance at high temperature and that exhibits high reliability even with a high-power battery configuration.

2. Description of Related Art

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, lithium-ion batteries that perform charge and discharge by transferring lithium ions between the positive and negative electrodes have been widely used as the driving power sources for the mobile information terminal devices.

The mobile information terminal devices tend to have higher power consumption according to the functions of the devices, such as a moving picture playing function and gaming functions. It is strongly desired that the lithium-ion batteries that are the drive power source for the devices have further higher capacities and higher performance in order to achieve longer battery life and improved output power.

Under these circumstances, lithium-transition metal composite oxides, such as LiCoO₂, LiNiO₂, and LiMn₂O₄ having a spinel structure, have been used as positive electrode active materials for the lithium-ion secondary batteries.

LiCoO₂ has been in wide commercial use as a positive electrode material that has a potential versus metallic lithium of about 4 V. LiCoO₂ has been considered an ideal positive electrode material in various aspects because it achieves a high energy density as well as a high voltage.

Nevertheless, cobalt, one of the source materials of LiCoO₂, is a scare natural resource that is produced only in limited regions. This is undesirable in terms of cost and stable supply of a positive electrode active material for non-aqueous electrolyte batteries, the demand for which is expected to grow further.

LiNiO₂ is also considered a desirable positive electrode material because it has a high theoretical capacity, shows a high discharge potential, and is lower in cost than LiCoO₂. A problem with LiNiO₂ is that the crystal structure degrades as the charge-discharge cycle progresses, leading to degradation in discharge capacity. Moreover, the thermal stability is rather poor.

LiMn₂O₄ having a spinel structure has a high potential comparable to LiCoO₂ and can produce a high battery capacity. Moreover, LiMn₂O₄ having a spinel structure is advantageous in terms of cost since it can be synthesized easily. Therefore, LiMn₂O₄ having a spinel structure is also considered a desirable positive electrode material. A problem with the use of the LiMn₂O₄ is, however, that the battery tends to suffer a rather large capacity loss when stored at high temperature. In addition, battery stability or cycle performance may not be sufficient since manganese dissolves into the electrolyte solution.

In view of these problems, Japanese Published Unexamined Patent Application Nos. 9-134724, 9-134725, and 2001-085010, for example, propose, as a positive electrode active material, an olivine lithium iron phosphate-based compound (LiFePO₄), using iron as a source material, which is produced abundantly and is thus low in cost, and a material in which a portion of the iron in the LiFePO₄ is substituted by another element.

The olivine lithium iron phosphate-based compound (LiFePO₄) is suited as a positive electrode material for diversified non-aqueous electrolyte batteries since the olivine lithium iron phosphate-based compound is inexpensive and shows a high theoretical capacity and good thermal stability. Moreover, the olivine lithium phosphate-based compound has a strong bond between phosphorus and oxygen, so it can maintain a stable structure even at high temperatures, in comparison with oxide positive electrode materials. For this reason, the olivine lithium phosphate-based compound is considered a promising material for large-sized batteries such as for use in power sources of HEVs.

However, lithium phosphate-based compounds such as olivine lithium iron phosphate-based compounds have a low volume energy density, resulting in poor battery performance, if used alone. In view of this problem, a technique of mixing an olivine lithium phosphate-based compound with a commonly used lithium-transition metal composite oxide having a layered structure or with a commonly used lithium-transition metal composite oxide having a spinel structure has been proposed. For example, Japanese Published Unexamined Patent Application No. 2002-216755 discloses a technique for improving battery reliability using such a positive electrode mixture.

It has been found, however, that a positive electrode containing a lithium phosphate-based compound in a charged state suffers from a considerable deterioration in battery performance at high temperature. The primary cause is believed to be as follows. Under high temperature conditions, the crystal structure of the lithium phosphate-based compound that has released lithium loses its stability, and therefore, the transition metal ions within the lithium phosphate-based compound dissolve into the electrolyte solution. Consequently, the transition metal ions undergo reduction and deposit on the negative electrode, thereby causing an increase in internal resistance and the resulting capacity degradation.

In particular, battery performance deterioration during storage is significant when the lithium phosphate-based compound (LiMPO₄) contains iron as the transition metal M since the iron tends to dissolve into the electrolyte solution easily in the charged state under high temperature conditions. It is believed that this dissolution of iron occurs due to the unreacted material produced during the synthesis of LiFePO₄ (note that although not a metallic element, iron oxide, etc. can dissolve into the electrolyte solution with the voltage of the non-aqueous electrolyte battery), or due to the deterioration of the crystal structure of LiFePO₄ associated with charge-discharge reactions.

It has also been found that the deterioration during storage takes place significantly when the lithium phosphate-based compound is mixed with a lithium-transition metal composite oxide, although it can occur when the lithium phosphate-based compound is used alone. This is because, when a lithium-transition metal composite oxide is mixed with a lithium phosphate-based compound, the potential of the lithium phosphate-based compound becomes higher in a charged state, causing the lithium phosphate-based compound to be more unstable than when the lithium phosphate-based compound is used alone. Specifically, when LiFePO₄ is used as the lithium phosphate-based compound, the lithium insertion-deinsertion potential of LiFePO₄ itself is low, from 3.3 V to 3.6 V, and the OCV (Open Circuit Voltage) is about 3.6 V even in the fully charged state. On the other hand, when LiFePO₄ is mixed with a positive electrode material that has a nobler potential of about 4 V, such as lithium cobalt oxide, spinel-type lithium manganese oxide, or LiNi_{1/3}Co_{1/3}Mn_{1/3}O₂, the OCV results in a higher voltage, originating from the potential of the material mixed with LiFePO₄. As a result, the iron is exposed to a potential at which the iron can dissolve more easily. Thus, it is believed that the mixture-based positive electrode system has a higher risk of the dissolution of iron.

### BRIEF SUMMARY OF THE INVENTION

Accordingly, it is an object of the present invention to provide a non-aqueous electrolyte battery that shows good cycle performance and good storage performance even when an olivine lithium phosphate-based compound is used as the positive electrode active material and that exhibits high reliability even with a battery configuration featuring high output power.

In order to accomplish the foregoing and other objects, the present invention provides a non-aqueous electrolyte secondary battery comprising: a positive electrode having a positive electrode active material containing an olivine lithium phosphate-based compound having an elemental composition represented as LiMPO₄, where M is a transition metal including at least Fe; a negative electrode having a negative electrode active material; a separator interposed between the positive electrode and the negative electrode; a porous layer containing inorganic particles and a binder, the porous layer interposed between the separator and the positive electrode and/or between the separator and the negative electrode; an electrode assembly comprising the positive electrode, the negative electrode, the porous layer and the separator; and a non-aqueous electrolyte impregnated in the electrode assembly, wherein: the product of separator thickness x (μm) and separator porosity y (%) is equal to or less than 1500 (μm·%).

According to the present invention, the porous layer(s) provided at least either between the positive electrode and the separator or between the negative electrode and the separator exhibits (exhibit) a filtering such that pores or gaps in the porous layer trap decomposition products of the electrolyte and iron but do not inhibit the transfer of lithium ions. Thus, the porous layer(s) traps (trap) the decomposition product of the electrolyte solution resulting from the reaction at the positive electrode, the iron ions dissolved away from the positive electrode active material, and so forth, preventing the deposition of the transition metal, such as iron, on the negative electrode and the separator. As a result, damage to the negative electrode and the separator is alleviated, and therefore, an excellent advantageous effect is exhibited, the deterioration in the cycle performance under high temperature conditions and the deterioration in the storage performance under high temperature conditions can be lessened. When using a binder that has a strong binding capability with the inorganic particles, higher stability and strength are imparted to the layer than when the layer is formed by the binder alone, and a more favorable filtering function can be exhibited. Moreover, since a plurality of particles is entangled in the formed layer, a complicated and complex filter layer is formed, so the effect of physical trapping is also enhanced.

### BRIEF DESCRIPTION OF THE DRAWINGS

FIG. 1 is a graph illustrating the relationship between remaining capacities and separator pore volumes after stored in a charged state; and

FIG. 2 is an enlarged view showing a portion of the graph of FIG. 1.

### DETAILED DESCRIPTION OF THE INVENTION

A non-aqueous electrolyte secondary battery according to the present invention comprises a positive electrode having a positive electrode active material, a negative electrode having a negative electrode active material, a separator interposed between the positive electrode and the negative electrode, an electrode assembly comprising the positive electrode, the negative electrode, and the separator, and a non-aqueous electrolyte impregnated in the electrode assembly. The positive electrode active material contains an olivine lithium phosphate-based compound having an elemental composition represented as LiMPO₄, where M is a transition metal including at least Fe. The product of separator thickness x (μm) and separator porosity y (%) is controlled to be equal to or less than 1500 (μm·%). The non-aqueous electrolyte secondary battery is also provided with a porous layer containing inorganic particles and a binder. The porous layer is interposed between the separator and the positive electrode and/or between the separator and the negative electrode.

In the above-described configuration, the binder contained in the porous layer absorbs the electrolyte solution and swells, and as a result, the swollen binder fills up the gaps between the inorganic particles to a sufficient degree to enable the porous layer to exhibit the desired filtering of the decomposition products of the electrolyte and iron. This makes it possible to alleviate damage to the negative electrode and the separator. Therefore, the deterioration in cycle performance under high temperature conditions and deterioration in the storage performance under high temperature conditions can be lessened. Moreover, the binder firmly bonds the inorganic particles to one another, as well as the porous layer and the separator, and the porous layer and the positive and negative electrodes, preventing the porous layer from coming off from the separator. Thus, the above-described advantageous effect is maintained for a long period.

The reason why the pore volume of the separator is restricted to 1500 (μm·%) or less is as follows. A separator with a smaller pore volume is more susceptible to the adverse effects from the deposition and the side reaction products and tends to show a more significant deterioration in battery performance. For this reason, a remarkable advantageous effect is exhibited by applying the present invention to the battery having a separator with the above restriction.

Examples of the transition metal M of the olivine lithium phosphate-based compound used in the present invention, which has the elemental composition represented as LiMPO₄ (where M is a transition metal including at least Fe), include cobalt, nickel, manganese, copper, magnesium, zinc, calcium, chromium, strontium, and barium, in addition to iron.

It is preferable that the olivine lithium phosphate-based compound be a lithium iron phosphate-based compound having an elemental composition represented as LiFePO₄.

When the olivine lithium phosphate-based compound is a lithium iron phosphate-based compound, the present invention is expected to be more effective because iron is more easily dissolved away than the other transition metals, especially in a charged state under high temperature conditions.

In addition, since iron is a low cost material, the manufacturing cost of the battery can be reduced.

It is preferable that the inorganic particles be made of a rutile-type titania and/or alumina.

Rutile-type titania and/or alumina as described above are preferable because these materials show good stability inside the battery (low reactivity with lithium) and are low in cost. The reason why rutile-type titania is employed is as follows. Anatase-type titania is capable of insertion and deinsertion of lithium ions, and therefore it can absorb lithium and exhibit electron conductivity, depending on the surrounding atmosphere and or the potential, so there is a risk of capacity degradation and short circuiting. Inorganic particles made of other materials can also be used as long as the materials do not occlude lithium ions and satisfy the conditions described hereinafter.

It is preferable that the inorganic particles have an average particle size greater than the average pore size of the separator.

When the inorganic particles have an average particle size smaller than the average pore size of the separator, the separator may be pierced in some portions when winding and pressing the electrode assembly during the fabrication of the battery, and consequently the portions may have a low resistance. This may result in a defective battery, and moreover, the inorganic particles may come into the pores of the separator, degrading various characteristics of the battery. To avoid this problem, the average particle size of the inorganic particles should be controlled as described above.

It is preferable that the inorganic particles have an average particle size of 1 μm or less. In addition, taking the dispersion capability in a slurry into consideration, it is preferable to use inorganic particles subjected to a surface treatment with aluminum, silicon, or titanium. In the surface treatment, an inorganic salt of the material used for coating is dispersed in a solution in which the inorganic particles are dispersed and stirred under alkaline conditions. The particles are thereafter fired at a predetermined temperature.

It is preferable that the porous layer have a thickness of 4 μm or less.

Although the above-described advantageous effects become more significant when the thickness of the porous layer is larger, an excessively large thickness of the porous layer is problematic. If the thickness of the porous layer is too large, the internal resistance of the battery will increase, and consequently, load characteristics may degrade. In addition, because an excessively large thickness of the porous layer means a smaller amount of the active material in each of the positive and negative electrodes, the energy density of the battery also reduces. For that reason, it is desirable that the porous layer have a thickness of 4 μm or less, more desirably 2 μm or less. It should be noted that the trapping effect is sufficiently obtained even when the thickness of the porous layer is small because the porous layer has a complicated, complex structure of openings and pathways formed by layering of the inorganic particles in the thickness direction of the layer. It should be noted that when the porous layer is formed on only one side of the separator (or on one side of each of the positive and negative electrodes), the thickness of the porous layer means the thickness of that layer, while when both sides of the separator (or both sides of the positive and negative electrodes) are provided with respective porous layers, the thickness of the porous layer means the thickness of the porous layer on one side.

It is preferable that the positive electrode active material contain at least one type of lithium-transition metal composite oxide having an operating potential nobler than that of the olivine lithium phosphate-based compound. A preferable example of the lithium-transition metal composite oxide is LiNi_{1/3}Co_{1/3}Mn_{1/3}O₂.

An olivine lithium phosphate-based compound, used in the present invention, has a low volume energy density and may result in poor battery performance, if used alone. The just-mentioned problem is alleviated by allowing the positive electrode active material to contain at least one type of lithium-transition metal composite oxide having an operating potential nobler than that of the olivine lithium phosphate-based compound (for example, a lithium-transition metal composite oxide having a layered structure, or a lithium-transition metal composite oxide having a spinel structure, which are commonly used).

The lithium-transition metal composite oxide having an operating potential nobler than that of the olivine lithium phosphate-based compound is not particularly limited, and may be a lithium composite oxide containing cobalt or manganese, such as a lithium-cobalt-nickel-manganese composite oxide, a lithium-aluminum-nickel-manganese composite oxide, and a lithium-aluminum-nickel-cobalt composite oxide, as well as a spinel-type lithium manganese oxide. However, taking the capacity of the positive electrode into consideration, it is preferable to use lithium cobalt oxide, a lithium-cobalt-nickel-manganese composite oxide, a lithium-aluminum-nickel-manganese composite oxide, a lithium-aluminum-nickel-cobalt composite oxide, and the like.

LiFePO₄, however, has a low insertion-deinsertion potential, as mentioned previously, so when charged with a cut-off voltage of 4.2 V, it achieves a large difference between the cut-off voltage and the operating voltage in high-rate charging. Therefore, LiFePO4 exhibits very advantageous characteristics in applications where a rapid charge is desired. To achieve a capacity increase while making use of such an advantageous feature, it is preferable to add a high-capacity positive electrode active material that similarly shows a low lithium insertion-deintercalation potential. For this reason, it is preferable to add a lithium-cobalt-nickel-manganese composite oxide, a lithium-aluminum-nickel-manganese composite oxide, and a lithium-aluminum-nickel-cobalt composite oxide. Especially preferable is a lithium-cobalt-nickel-manganese composite oxide represented by the general formula LiNi_{1/3}CO_{1/3}Mn_{1/3}O₂.

It is preferable that the product of x and y be controlled to be 1100 (μm·%) or less.

The performance deterioration tends to be worse in a battery that uses such a separator. Therefore, the present invention can be more effective for the battery that uses such a separator.

It should be noted that such a battery may also achieve an improvement in the energy density because such a battery accomplishes a separator thickness reduction.

Additional Important Matters Relating to the Present Invention

(1) When considering the advantageous effect of the present invention, it is estimated that the larger the thickness of the porous layer, or the higher the concentration of the binder, the more effective the filtering function. However, it is believed that there is a trade-off between the advantageous effect of the present invention and the resistance increase between the electrodes (distance and mobility of lithium ions). For example, it has been found that when the concentration of the binder exceeds 50 mass % with respect to titanium oxide, the battery can be charged and discharged only to approximately half the design capacity, and thus, the performance of the battery significantly degrades. This is believed to be because the binder is filled between the inorganic particles of the porous layer and the mobility of lithium ions is extremely lowered. When the amount of the binder is so large, air permeability is believed to be very poor even before the binder absorbs the electrolyte solution and swells. Empirically it is believed preferable that the amount of binder be adjusted so that the measurement time of an air permeability test be 2.0 times or less than that of the separator without the porous layer, more preferably 1.5 times or less, and still more preferably 1.2 times or less. Even when the amount of binder is 1 mass %, the binder is reasonably uniformly dispersed in the porous layer by a dispersion process such as that using a Filmics mixer. It has been found that even when the amount of the binder added is only 2 mass %, the function as a filter is exhibited remarkably in addition to a high bonding strength.

From the foregoing, it is preferable that the amount of binder be as small as possible. However, when considering the physical strength for withstanding processing during battery fabrication, the filtering effect, and the ensuring of the dispersion capability of the inorganic particles in a slurry, it is preferable that the amount of binder be controlled to be within the range of from 1 to 30 mass %, preferably from 1 to 10 mass %, and particularly preferably from 2 to 5 mass %.

(2) Although the material of the binder of the porous layer in the present invention is not particularly limited, the binder is required to have the following functions and characteristic in order to exhibit the advantageous effect.

(I) A function to ensure binding capability for withstanding the manufacturing process of the battery

(II) A function to fill the gaps between the inorganic particles by swelling after absorbing the electrolyte solution

(III) A function to ensure the dispersion capability of the inorganic particles (to prevent reaggregation)

(IV) A characteristic of causing little dissolution into the electrolyte solution

Taking the above factors into consideration, PTFE (polytetrafluoroethylene), PVDF (polyvinylidene fluoride), PAN (polyacrylonitrile), SBR (styrene-butadiene rubber), and copolymers of acrylonitrile and acrylic acid ester and polyacrylic acid are preferable.

Inorganic particles made of titania or alumina have a high affinity with binders that have acrylonitrile-based molecular structures, and the binders that have these types of groups (molecular structures) show a higher dispersion capability. Accordingly, it is desirable to adopt a binder (copolymer) containing acrylonitrile units, which can exhibit the above-mentioned functions (I) and (II) even when added in a small amount, and which has the characteristic (IV) and also satisfies the function (III). Furthermore, to obtain strength without breaking or cracking after being bonded to the separator, a polymer having flexibility is preferable. From the foregoing, it is most preferable that the binder be a flexible polymer containing acrylonitrile units.

(3) In preparing the porous layer, a slurry containing the inorganic particles and the binder is applied to the positive electrode, the negative electrode, or the separator. Examples of the solvents that may be used when preparing the slurry include, but are not limited to, acetone, N-methyl-2-pyrrolidone, cyclohexanone, and water.

A suitable method for dispersing the slurry is a wet-type dispersion technique such as a bead mill technique, in addition to the above-mentioned Filmics. In particular, the particle size of the inorganic particles used is small in the present invention, so, unless a mechanical dispersion process is performed, sedimentation in the slurry is significant and a uniform film cannot be formed. For this reason, it is desirable to use a method that is used in the industrial field of paint for dispersing a paint. It is preferable that the concentration of the solid content in coating be low since the formation of a thin film needs to be carried out. That said, since the thickness of the coating may be controlled by scraping or the like, it is desirable to use a slurry having a solid content concentration of up to about 60 mass %.

(4) Possible methods for forming the porous layer between an electrode and the separator include two kinds of methods, a method in which the electrode is directly coated (the porous layer is formed directly on a surface of the positive electrode or the negative electrode) and a method in which the separator is directly coated.

Illustrative examples of the methods of coating the electrode directly include die coating, gravure coating, dip coating, curtain coating, and spray coating. The use of gravure coating or die coating is desirable because it is preferable to conduct intermittent coating in order to lessen the degradation of energy density resulting from the coating on excessive areas (unnecessary areas) and because an accurate thickness control (thin film coating) is required. Moreover, the use of a method that can perform the coating at a high speed that can reduce the time for drying is desirable in order to prevent problems such as a bonding strength degradation resulting from the diffusion of the solvent or the binder into the interior of the electrodes (bonding strength degradation of the positive electrode active material layer or the negative electrode active material layer because of melting of the existing binder) and a plate resistance increase resulting from the seeping of the binder into the interior of the electrodes.

On the other hand, usable examples of the methods of coating the separator include die coating and gravure coating, in addition to dip coating. However, in the methods other than dip coating, the slurry can be applied to only one side of the microporous film separator at a time, so when coating one side of the separator, the binder seeps through to the other side of the separator. This causes problems such as a change (dilution) of the binder concentration in the porous layer and an increase of the binder concentration in the interior of the separator when coating both sides, which results in a deterioration of air permeability. In order to avoid these problem, it is desirable to adopt a dip coating technique. Since this technique is capable of coating both sides at one time, the coat process can be simplified, and moreover, there is an additional advantage that uniform porous layers can be formed on both sides by varying the slurry concentration and the speed of coating. It should be noted that it is not particularly necessary to form the porous layer on both sides of the separator, and it is possible to form the porous layer on only one side thereof. However, since an object of the present invention is to prevent the reaction product and the like originating from the positive electrode surface from migrating to the separator or the negative electrode, it is desirable to provide the porous layer between the positive electrode and the separator. With the just-mentioned configuration, the reaction product and the like originating from the positive electrode surface can be trapped immediately (before migrating to the separator).

### Embodiment

Hereinbelow, the present invention is described in further detail based on examples thereof. It should be construed, however, that the present invention is not limited to the following examples but various changes and modifications are possible without departing from the scope of the invention.

Preparation of Positive Electrode

First, a lithium iron phosphate-based compound (LiFePO₄) having an average particle diameter of 0.8 μm, which is a positive electrode active material, and a carbonaceous conductive agent were mixed at a ratio of 92:5 to prepare a positive electrode mixture powder. Thereafter, a solution in which fluorocarbon polymer powder (polyvinylidene fluoride) as a binder agent is dissolved in an N-methyl-2-pyrrolidone was added to the positive electrode mixture powder, and they were mixed together. Thus, a positive electrode slurry was prepared. The mass ratio of the positive electrode mixture powder and the binder agent was adjusted to 97:3. Next, the resultant positive electrode slurry was applied onto both sides of a positive electrode current collector made of an aluminum foil by doctor blading. The resultant material was then dried and pressure-rolled. A positive electrode was thus prepared.

Preparation of Negative Electrode

A carbonaceous material (artificial graphite having an average particle diameter of 20 μm), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and pressure-rolled. Thus, a negative electrode was prepared.

Preparation of Non-Aqueous Electrolyte Solution

Lithium hexafluorophosphate (LiPF₆) was dissolved at a concentration of 1.0 mole/L in a mixed solvent of 3:7 volume ratio of ethylene carbonate (EC) and diethyl carbonate (DEC) to prepare a non-aqueous electrolyte solution.

Preparation of Separator

First, an acetone solvent was mixed with 5 mass %, based on the mass of acetone, of TiO₂ inorganic particles (rutile-type, particle size 0.38 μm, KR380 manufactured by Titan Kogyo Kabushiki Kaisha) and 10 mass %, based on the mass of TiO₂, of a copolymer acrylonitrile and n-hexylacrylic acid, and a mixing and dispersing process was carried out using a spin mixer (Filmics, made by Tokushu Kika Kogyo Kabushiki Kaisha). Thereby a slurry in which TiO₂ was dispersed was prepared. Next, the above-described slurry was applied onto both sides of a separator made of a microporous film (with a film thickness 12 μm and a porosity, as determined in a later-described manner, of 38%) of polyethylene (hereinafter also abbreviated as “PE”) by dip coating. The solvent of the slurry was then removed by drying, whereby a porous layer was formed on each side of the separator. The thickness of the porous layers was 2 μm in total on both sides, and the film thickness of the separator was 12 μm. Therefore, the total film thickness of the entire separator was 14 μm.

Measurement of Porosity of Separator

First, a sample of the film (separator) was cut into a 10 cm×10 cm square, and the mass (W g) and the thickness (D cm) of the sample were measured. The mass of each of the materials within the sample was determined by calculation, and the mass of each of the materials [Wi (i=1 to n)] was divided by the absolute specific gravity, to assume the volume of each of the materials. Then, porosity (volume %) was determined using the following equation 1.
Porosity (%)=100−{(W1/Absolute specific gravity 1)+(W2/Absolute specific gravity 2)++(Wn/Absolute specific gravity n)}100/(100D) (Eq. 1)

The separator in the present invention, however, is made of PE alone, and therefore, the porosity thereof can be determined using the following equation (2).
Porosity (%)=100−{(Mass of PE/Absolute specific gravity of PE)}100/(100D) (Eq. 2)

Construction of Battery

Lead terminals were attached to the positive and negative electrodes, and the positive and negative electrodes were wound in a spiral form with the separator on which the porous layers were formed on the surfaces. The wound electrodes were then pressed into a flat shape to obtain an electrode assembly, and thereafter, the electrode assembly was accommodated into an enclosing space made by an aluminum laminate film serving as a battery case. Then, the non-aqueous electrolyte solution was filled into the space, and thereafter the battery case was sealed by welding the aluminum laminate film together, to thus prepare a battery. The above-described battery had a design capacity of 300 mAh.

### EXAMPLES

### Example A1

A battery prepared in the manner described in the above embodiment was used for Example A1.

The battery fabricated in this manner is hereinafter referred to as Battery A1 of the invention.

### Example A2

A battery was fabricated in the same manner as described in Example A1 above, except that a separator having a film thickness of 18 m and a porosity of 45% [pore volume 810 (μm·%)] was used as the separator.

The battery fabricated in this manner is hereinafter referred to as Battery A2 of the invention.

### Example A3

A battery was fabricated in the same manner as described in Example A1 above, except that a separator having a film thickness of 27 μm and a porosity of 52% [pore volume 1404 (μm·%)] was used as the separator.

The battery fabricated in this manner is hereinafter referred to as Battery A3 of the invention.

### Example A4

A battery was fabricated in the same manner as described in Example A1, except that a mixture of 90:10 mass ratio of lithium iron phosphate-based compound (LiFePO₄) and lithium-nickel-cobalt-manganese composite oxide (LiNi_{1/3}Co_{1/3}Mn_{1/3}O₂) was used as the positive electrode active material.

The battery fabricated in this manner is hereinafter referred to as Battery A4 of the invention.

### Comparative Example Z1

A battery was fabricated in the same manner as described in Example A1 above, except that no porous layer was provided on the separator.

The battery fabricated in this manner is hereinafter referred to as Comparative Battery Z1.

### Comparative Example Z2

A battery was fabricated in the same manner as described in Example A1 above, except that a separator having a film thickness of 16 μm and a porosity of 47% [pore volume 752 (μm·%)] was used as the separator, and that no porous layer was provided on the separator.

The battery fabricated in this manner is hereinafter referred to as Comparative Battery Z2.

### Comparative Example Z3

A battery was fabricated in the same manner as described in Example A2 above, except that no porous layer was provided on the separator.

The battery fabricated in this manner is hereinafter referred to as Comparative Battery Z3.

### Comparative Example Z4

A battery was fabricated in the same manner as described in Example A1 above, except that a separator having a film thickness of 23 μm and a porosity of 48% [pore volume 1104 (μm·%)] was used as the separator, and that no porous layer was provided on the separator.

The battery fabricated in this manner is hereinafter referred to as Comparative Battery Z4.

### Comparative Example Z5

A battery was fabricated in the same manner as described in Example A3 above, except that no porous layer was provided on the separator.

The battery fabricated in this manner is hereinafter referred to as Comparative Battery Z5.

### Comparative Example 6

A battery was fabricated in the same manner as described in Example A4 above, except that no porous layer was provided on the separator.

The battery fabricated in this manner is hereinafter referred to as Comparative Battery Z6.

Experiment

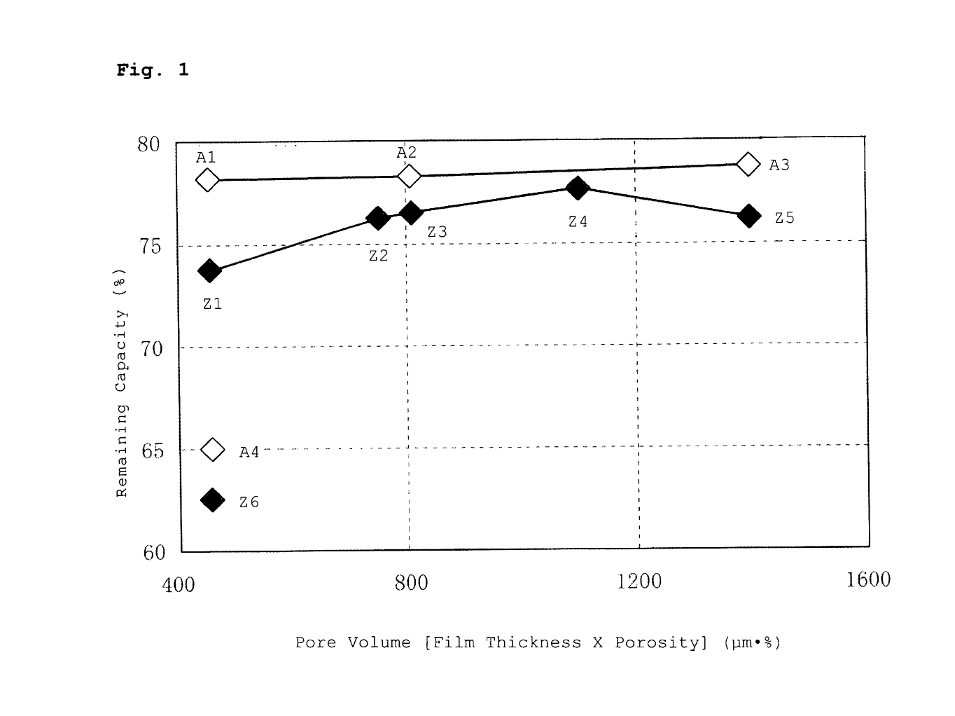

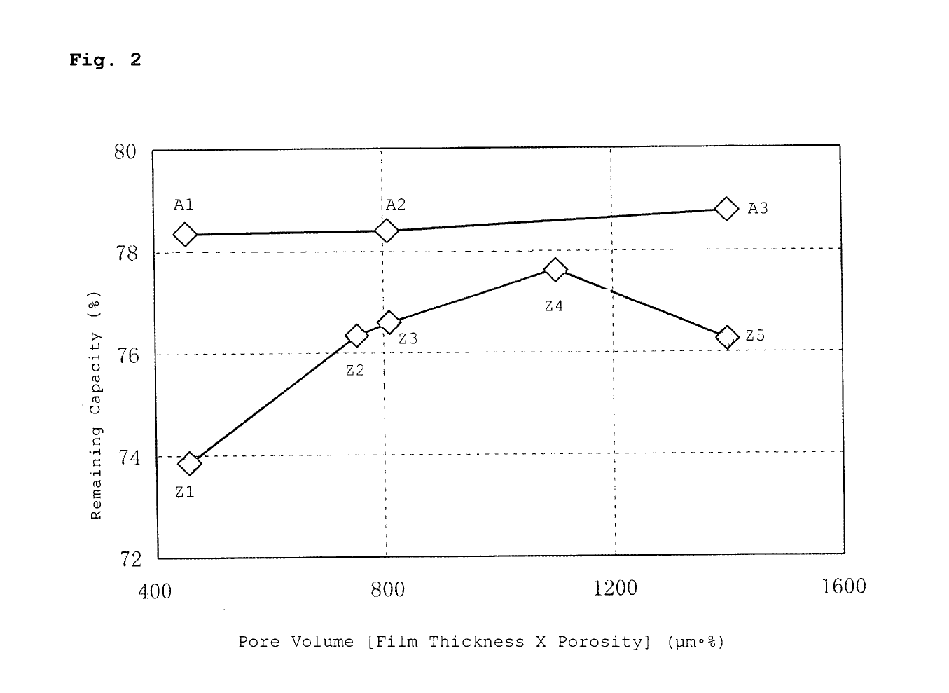

The storage performance in a charged state (the remaining capacity after storage in a charged state) was studied for each of Batteries A1 to A4 and Comparative Batteries Z1 to Z6. The results are shown in Table 1 below. Based on the results obtained, a correlation between the physical characteristic (pore volume) of the separator and the remaining capacity after storage in a charged state was also studied. The results are shown in FIGS. 1 and 2 (FIG. 2 is a graph showing a portion of FIG. 1 enlarged). The charge-discharge conditions and storage conditions were as follows.

Charge-Discharge Conditions

Charge Conditions

Each of the batteries was charged at a constant current of

1.0 It (300 mA) until the battery voltage reached 4.20 V, and thereafter charged at a predetermined voltage until the current value reached 1/20 It (15.0 mA).

Discharge Conditions

Each of the batteries was discharged at a constant current of 1.0 It (300 mA) until the battery voltage reaches 2.40 V.

The interval between the charge and the discharge was 10 minutes.

Storage Conditions

Each of the batteries was charged and discharged one time according to the charge-discharge conditions, and was again charged according to the charge conditions specified above to the predetermined voltage. Then, each battery was set aside at 60° C. for 24 hours.

Determination of Remaining Capacity

Each of the batteries was cooled to room temperature (25° C.) and discharged under the same conditions as the above-described discharge conditions, to measure the remaining capacity. Using the discharge capacity obtained at the first-time discharge after the storage test and the discharge capacity obtained before the storage test, remaining capacity was calculated using the following equation (3).
Remaining capacity (%)=Discharge capacity obtained at the first-time discharge after storage test/Discharge capacity obtained before storage test×100. Eq. (3)

TABLE 1

| | Separator | | | Porous layer | | | | | | |
|---|---|---|---|---|---|---|---|---|---|---|
| | | | Pore | | Concentration | | | Positive | | |
| | | | volume | | of | | | electrode | | |
| | Film | | [Film | | titanium | Concentration | | active | End-of- | Remain- |
| | thick- | Poros- | thickness × | Po- | oxide | of binder to | Thickness | material | charge | ing |
| | ness | ity | Porosity] | rous | to acetone | titanium oxide | [both sides] | (mass | voltage | capacity |
| Battery | (μm) | (%) | (μm %) | layer | (mass %) | (mass %) | (μm) | ratio) | (V) | (%) |
| A1 | 12 | 38 | 456 | Yes | 5 | 10 | 2 | LiFePO₄ | 4.20 | 78.3 |
| A2 | 18 | 45 | 810 | | | | | | | 78.4 |
| A3 | 27 | 52 | 1404 | | | | | | | 78.8 |
| Z1 | 12 | 38 | 456 | No | — | — | — | | | 73.9 |
| Z2 | 16 | 47 | 752 | | | | | | | 76.3 |
| Z3 | 18 | 45 | 810 | | | | | | | 76.6 |
| Z4 | 23 | 48 | 1104 | | | | | | | 77.6 |
| Z5 | 27 | 52 | 1404 | | | | | | | 76.3 |
| A4 | 12 | 38 | 456 | Yes | 5 | 10 | 2 | LiFePO₄:LiNi_{1/3}CO_{1/3}Mn_{1/3}O₂ | | 64.9 |
| Z6 | | | | No | — | — | — | (90:10) | | 62.6 |

When LiFePO₄ Alone was Used as the Positive Electrode Active Material

The results shown in Table 1 and FIGS. 1 and 2 clearly demonstrate that Comparative Batteries Z1 to Z4, which do not have a porous layer, show a poorer remaining capacity (the degree of the capacity deterioration is greater) when the separator has a smaller pore volume. In contrast, Batteries A1 to A3 of the invention, in each of which the porous layer is formed on both sides of the separator, do not suffer a considerable decrease in the remaining capacity after storage, even when the separator has a small pore volume.

These results of the experiment are believed to be attributable to the following reason. In Comparative Batteries Z1 to Z4, when the pore volume of the separator is smaller, the iron or the like that dissolves away from the positive electrode is more likely to deposit in the separator, and the clogging of the separator is more likely to occur. In contrast, in Batteries A1 to A3 of the invention, the iron or the like dissolved away from positive electrode is trapped by the layer of the inorganic particles that is interposed between the electrodes and the separator. Therefore, even when the separator has a small pore volume, it is possible to prevent the deposition of the iron in the separator, and the clogging of the separator does not easily occur.

When the Positive Electrode Active Material Contains LiFePO4 and LiNi_{1/3}Co_{1/3}Mn_{1/3}O₂

As clearly seen from Table 1 and FIG. 1, with the batteries using a mixed positive electrode of LiFePO₄ and LiNi_{1/3}Co_{1/3}Mn_{1/3}O₂, Battery A4 of the invention, which has the porous layer, exhibits a higher remaining capacity after storage in a charged state than Comparative Battery Z6, which does not have a porous layer, proving that the storage performance improves. It is also recognized that Comparative Battery Z6 shows a greater deterioration in the remaining capacity after storage in a charged state than Comparative Batteries Z1 to Z5.

It should be noted that the technique of mixing LiFePO₄ with a lithium-transition metal composite oxide having a nobler operating potential than that of LiFePO₄, such as LiNi_{1/3}Co_{1/3}Mn_{1/3}O₂ is indispensable in order to achieve a high capacity as well as a high power of a battery. However, when LiFePO₄ is mixed with a positive electrode active material having a nobler operating potential than that of LiFePO₄, the potential of the LiFePO₄ in the mixed positive electrode active material becomes higher than when the positive electrode active material contains LiFePO₄ alone, so LiFePO₄ becomes unstable. Consequently, it is believed that in Comparative Battery Z6, which used the mixed positive electrode active material, the amount of the iron that dissolved away was greater than in Comparative Batteries Z1 to Z5, which used the positive electrode active material containing LiFePO₄ alone, resulting in a poorer remaining capacity. On the other hand, even in the cases of using the mixed positive electrode active material, Battery A4 of the invention, which has a porous layer, showed a higher remaining capacity and improved storage performance because it is believed that the inorganic particles interposed between the electrodes and the separator trap the iron or the like that dissolved away from the positive electrode.

Although it is essential to reduce the film thickness of the separator in order to achieve a higher capacity and a higher output power of the battery, such a battery configuration is more susceptible to clogging of the pores in the separator, and the deterioration of the storage performance becomes more noticeable. For this reason, it is desirable to apply the present invention to a battery for use in high capacity, high power applications, that uses LiFePO₄ or the like as the positive electrode active material and has a separator with a reduced thickness.

The present inventors have confirmed through an experiment that the advantageous effect of the present invention is sufficiently obtained when the pore volume of the separator [the product xy of the thickness x (μm) of the separator and the porosity y (%) of the separator] is 1500 (μm·%) or less, and that the advantageous effect is obtained to a remarkable degree especially when the pore volume is 1100 (μm·%) is less. Although the advantageous effect is expected to be similar even when the pore volume of the separator exceeds 1500 (μm·%), additional problems of an increase in the internal resistance of the battery and a decrease in the energy density arise in that case. For this reason, it is preferable that the pore volume of the separator be equal to or less than 1500 (μm·%), and particularly preferably 1100 (μm·%) or less.

### Other Embodiments

(1) The porous layer does not need to be formed on both sides of the separator, but may be formed only on one side thereof. When the porous layer is formed on only one side of the separator, the battery capacity is prevented from reducing since the thickness of the separator becomes smaller. When the porous layer is formed on only one side of the separator, it is desirable that the porous layer be formed on the positive electrode side of the separator so that the trapping effect can be enhanced. Moreover, the porous layer may be formed on a surface of the positive electrode active material layer or a surface of the negative electrode active material layer. However, if the porous layer is formed on the surfaces of both of the active material layers, the solvent or the binder may diffuse into the interiors of both active material layers, and consequently, the binding capability of the inorganic particles may degrade. For this reason, it is most preferable that the porous layer be coated on a surface of the separator.

(2) The negative electrode active material is not limited to graphite described above. Various other materials may be employed, such as coke, tin oxides, metallic lithium, silicon, and mixtures thereof, as long as the material is capable of intercalating and deintercalating lithium ions.

(3) The lithium salt of the electrolyte solution is not limited to LiPF₆, and various other substances may be used, including LiBF₄, LiAsF₆, LiCF₃SO₃, LiN(ClF₂₁₊₁SO₂) (CmF₂ₘ₊₁SO₂) (where 1 and m are integers equal to or greater than 0), LiC(CₚF₂ₚ₊₁SO₂) (C_{q}F_{2q+1}SO₂) (CrF₂ᵣ₊₁SO₂) (where p, q, and r are integers equal to or greater than 0), which may be used either alone or in combination of two or more of them. Although the concentration of the lithium salt is not particularly limited, it is preferable to control the concentration of the lithium salt within the range of from 0.5 moles to 1.5 moles per 1 liter of the electrolyte solution.

(4) Although the solvents for the electrolyte solution are not particularly limited to ethylene carbonate (EC) and diethyl carbonate (DEC) mentioned above, it is preferable that the electrolyte solution contain at least one type of cyclic carbonic ester compound having a C═C unsaturated bond. Examples of such cyclic carbonic ester compounds include vinylene carbonate, 4,5-dimethyl vinylene carbonate, 4,5-diethyl vinylene carbonate, 4,5-dipropyl vinylene carbonate, 4-ethyl-5-methyl vinylene carbonate, 4-ethyl-5-propyl vinylene carbonate, 4-methyl-5-methylvinylene carbonate, vinyl ethylene carbonate, and divinyl ethylene carbonate. When the electrolyte solution contains a cyclic carbonic ester compound having a C═C unsaturated bond as described above, a chemically stable surface film forms on the negative electrode, preventing the deposition of the transition metal that dissolves away from the positive electrode.

Preferable examples of the solvents for the electrolyte solution used in the present invention, to further enhance the effect of the surface film formation resulting from the cyclic carbonic ester compound having a C═C unsaturated bond, include carbonate-based solvents such as ethylene carbonate, propylene carbonate, diethyl carbonate, ethyl methyl carbonate, and dimethyl carbonate. More preferable is a combination of a cyclic carbonate and a chain carbonate.

(5) The present invention may be applied not only to liquid-type batteries but also to gelled polymer batteries. In this case, usable examples of the polymer materials include polyether-based solid polymer, polycarbonate-based solid polymer, polyacrylonitrile-based solid polymer, oxetane-based polymer, epoxy-based polymer, and copolymers or cross-linked polymers comprising two or more of these polymers, as well as PVDF. Any of the above examples of the polymer materials may be used in combination with a lithium salt and an electrolyte, to form a gelled solid electrolyte.

The present invention is suitable for driving power sources for mobile information terminals such as mobile telephones, notebook computers, and PDAs, especially for use in applications that require a high capacity. The invention is also expected to be used for high power applications that require continuous operations under high temperature conditions, such as HEVs and power tools, in which the battery operates under severe operating environments.

Only selected embodiments have been chosen to illustrate the present invention. To those skilled in the art, however, it will be apparent from the foregoing disclosure that various changes and modifications can be made herein without departing from the scope of the invention as defined in the appended claims.

Furthermore, the foregoing description of the embodiments according to the present invention is provided for illustration only, and is not intended to limit the invention as defined by the appended claims and their equivalents.

This application claims priority of Japanese patent application No. 2006-074557 filed Mar. 17, 2006, which is incorporated herein by reference.

What is claimed is:

1. A non-aqueous electrolyte secondary battery comprising:
a positive electrode having a positive electrode active material containing an olivine lithium phosphate-based compound having an elemental composition represented as LiMPO₄, where M is a transition metal including at least Fe;
a negative electrode having a negative electrode active material;
a separator interposed between the positive electrode and the negative electrode;
a porous layer containing inorganic particles and a binder for the inorganic particles, the porous layer interposed between the separator and the positive electrode and/or between the separator and the negative electrode;
an electrode assembly comprising the positive electrode, the negative electrode, the porous layer and the separator; and
a non-aqueous electrolyte impregnated in the electrode assembly, wherein the product of separator thickness x (μm) and separator porosity y (%) is equal to or less than 1500 (μm·%).

2. The non-aqueous electrolyte battery according to claim 1, wherein the olivine lithium phosphate-based compound is a lithium iron phosphate-based compound having an elemental composition represented as LiFePO₄.

3. The non-aqueous electrolyte battery according to claim 1, wherein the inorganic particles are made of a rutile-type titania and/or alumina.

4. The non-aqueous electrolyte battery according to claim 2, wherein the inorganic particles are made of a rutile-type titania and/or alumina.

5. The non-aqueous electrolyte battery according to claim 1, wherein the inorganic particles have an average particle size greater than the average pore size of the separator.

6. The non-aqueous electrolyte battery according to claim 2, wherein the inorganic particles have an average particle size greater than the average pore size of the separator.

7. The non-aqueous electrolyte battery according to claim 3, wherein the inorganic particles have an average particle size greater than the average pore size of the separator.

8. The non-aqueous electrolyte battery according to claim 4, wherein the inorganic particles have an average particle size greater than the average pore size of the separator.

9. The non-aqueous electrolyte battery according to claim 1, wherein the porous layer has a thickness of 4 μm or less.

10. The non-aqueous electrolyte battery according to claim 2, wherein the porous layer has a thickness of 4 μm or less.

11. The non-aqueous electrolyte battery according to claim 3, wherein the porous layer has a thickness of 4 μm or less.

12. The non-aqueous electrolyte battery according to claim 5, wherein the porous layer has a thickness of 4 μm or less.

13. The non-aqueous electrolyte battery according to claim 8, wherein the porous layer has a thickness of 4 μm or less.

14. The non-aqueous electrolyte battery according to claim 1, wherein the positive electrode active material contains at least one type of lithium-transition metal composite oxide having an operating potential nobler than that of the olivine lithium phosphate-based compound.

15. The non-aqueous electrolyte battery according to claim 2, wherein the positive electrode active material contains at least one type of lithium-transition metal composite oxide having an operating potential nobler than that of the olivine lithium phosphate-based compound.

16. The non-aqueous electrolyte battery according to claim 14, wherein the lithium-transition metal composite oxide is LiNi_{1/3}Co_{1/3}Mn_{1/3}O₂.

17. The non-aqueous electrolyte battery according to claim 15, wherein the lithium-transition metal composite oxide is LiNi_{1/3}Co_{1/3}Mn_{1/3}O₂.

18. The non-aqueous electrolyte battery according to claim 1, wherein the product of x and y is 1100 (μm·%) or less.

19. The non-aqueous electrolyte battery according to claim 2, wherein the product of x and y is 1100 (μm·%) or less.

20. The non-aqueous electrolyte battery according to claim 3, wherein the product of x and y is 1100 (μm·%) or less.
